(19) United States
(12) Patent Application Publication
(10) Pub. No.: US 2022/0245841 A1
(43) Pub. Date: Aug. 4, 2022

(54) DOMAIN ADAPTATION FOR DEPTH DENSIFICATION

(71) Applicant: HUAWEI TECHNOLOGIES CO., LTD., Shenzhen (CN)

(72) Inventors: Adrian LOPEZ RODRIGUEZ, London (GB); Benjamin BUSAM, London (GB); Gregory SLABAUGH, London (GB); Ales LEONARDIS, London (GB)

(21) Appl. No.: 17/726,668

(22) Filed: Apr. 22, 2022

Related U.S. Application Data
(63) Continuation of application No. PCT/EP2019/079001, filed on Oct. 24, 2019.

(51) Int. Cl. G06T 7/50; G06N 20/00

(52) U.S. Cl. CPC G06T 7/50; G06N 20/00; G06T 2207/20081; G06T 2207/10028; G06T 2207/30252

(57) ABSTRACT

A method for training an environmental analysis system, the method comprising: receiving a data model of an environment; forming, in dependence on the data model, a first training input comprising a visual stream representing the environment as viewed from a plurality of locations; forming, in dependence on the data model, a second training input comprising a depth stream representing depths of objects in the environment relative to the plurality of locations; forming a third training input, the third training input being sparser than the second training input; and estimating, using the analysis system, in dependence on the first and third training inputs, a series of depths at less sparsity than the third training input; and adapting the analysis system in dependence on a comparison between the estimated series of depths and the second training input.

### CROSS-REFERENCE TO RELATED APPLICATIONS

This application is a continuation of International Application No. PCT/EP2019/079001, filed on Oct. 24, 2019, the disclosure of which is hereby incorporated by reference in its entirety.

### TECHNICAL FIELD

This disclosure relates to image processing: for example processing image data and relatively sparse depth data to form denser depth data, and training models to perform such processing.

### BACKGROUND

Sensing technologies such as RADAR, LiDAR, ultrasound or other time-of-flight techniques utilize the fact that a wave with known properties is emitted and then reflected back from objects with specific density characteristics. If the travelling speed of the wave and the environmental characteristics are known, the echo or the reflection can be used to determine the time the wave took to travel through a medium and then the distance to the points that made the signal reflect can be calculated. Depending on the technology, these waves may be electromagnetic or acoustic. The waves may be sent at various frequencies.

While many sensors of this kind, such as LiDAR, can be used to determine the distance of objects within a specified range quite accurately, they retrieve a relatively sparse sampling of the environment in particular if the scanned objects are further away from the sensor. Put another way, the data they provide about the depths of objects from a sensing point are discrete and there are significant gaps between the vectors along which depth data is provided. Comparing the distance measurements of the sparse depth sensor to a passively acquired optical sensor, the effect becomes apparent. FIG. 1 illustrates a scenario for the LiDAR case where an RGB image is used as a reference and the distances measured are projected onto the image, as described in Geiger, Andreas, Philip Lenz, and Raquel Urtasun, “Are we ready for autonomous driving? The kitti vision benchmark suite”, 2012 IEEE Conference on Computer Vision and Pattern Recognition (CVPR 2012). The RGB image shown at 101 (the image is rendered in grayscale in this figure) is acquired from a camera mounted on the roof top of a car close to a LiDAR scanner that rotates 360 degrees to acquire the data shown at 102 (bird's eye view). After projection of the acquired distances onto the RGB view, as shown at 103, the sparsity of the signal becomes apparent.

Many computer vision applications can benefit from knowledge of depth with reduced sparsity. In order to derive the depth in all pixels of the RGB image (or at least more pixels than the subset for which actual measurements are available), information from the original RGB image can be combined with the relatively sparse depth measurements from, for example, LiDAR, and a full resolution depth map can be estimated. This task is commonly known as depth completion. FIG. 2 shows an example of a generic depth completion pipeline. FIG. 2 shows the effect of an example of a generic depth completion pipeline.

It is known to train a deep neural network to perform depth completion, with the training being supervised from real ground truth data or with self-supervision from additional modalities or sensors such as a second camera, an inertial measurement unit or consecutively acquired video frames. (Self-supervision refers to a training of a neural network in the absence of an explicit ground truth supervision). This approach has the advantage that the sensed data is naturally representative of what can be expected in a real world application but it suffers from problems such as noisy data and the cost of data acquisition.

It is desirable to develop a system and method for training a depth estimator that at least partially addresses these problems.

### SUMMARY

According to one aspect, there is provided an example method for training an environmental analysis system, the method comprising: receiving a data model of an environment; forming, in dependence on the data model, a first training input comprising a visual stream representing the environment as viewed from a plurality of locations; forming, in dependence on the data model, a second training input comprising a depth stream representing the depth of objects in the environment relative to the plurality of locations; forming a third training input comprising a depth stream representing the depth of objects in the environment relative to the plurality of locations, the third training input being sparser than the second training input; and estimating by means of the analysis system, in dependence on the first and third training inputs, a series of depths at less sparsity than the third training input; and adapting the analysis system in dependence on a comparison between the estimated series of depths and the second training input.

The data model is a synthetic data model, e.g., of a synthetic environment. Thus, the steps of forming the first training input and the second training input may comprise inferring those inputs in a self-consistent manner based on the environment as defined by the data model. By using synthetic data to train the model, the efficiency and effectiveness of training may be improved.

The analysis system may be a machine learning system having a series of weights and the step of adapting the analysis system may comprise adapting the weights. The use of a machine learning system can assist in forming a model that provides good results on real-world data.

The third training input may be filtered and/or augmented to simulate data resulting from a physical depth sensor. This can improve the effectiveness of the resulting model on real world data.

The third training input may be filtered and/or augmented to simulate data resulting from a scanning depth sensor. This can improve the effectiveness of the resulting model on real world data.

The third training input may be filtered and/or augmented by adding noise. This can improve the effectiveness of the resulting model on real world data.

The method may comprise forming the third training input by filtering and/or augmenting the second training input. This can provide an efficient way to generate the third training input.

The second training input and the third training input may represent depth maps. This can assist in forming a model that is effective on real-world depth map data.

The third training input may be augmented to include, for each of the plurality of locations, depth data for vectors extending at a common angle to vertical from the respective location. This can help to mimic the data derived from a scanning sensor.

The third training input may be filtered by excluding data for vectors that extend from one of the locations to an object that has been determined to be at a greater or smaller depth further away from an estimate than a predetermined threshold.

This can help to mimic the data derived from a real-world sensor.

The third training input may be filtered by excluding data for vectors in dependence on the colour represented in the visual stream of an object towards which the respective vectors extend. This can help to mimic the data derived from a real-world sensor.

The data model may be a model of a synthetic environment.

The method may comprise repeatedly adapting the analysis system. The method may comprise performing the majority of such adaptations in dependence on data describing one or more synthetic environments. This can provide an efficient way to train a model.

The step of training the system may comprise training the system by means of a semi-supervised learning algorithm. This can provide efficient training results.

The method may comprise training the system by the steps of: providing a view of the environment orientationally and translationally centred on a first reference frame as input to the system and in response to that input estimating by means of the system the depths associated with pixels in that view; forming, in dependence on that view and the estimated depths, an estimated view of the environment orientationally and translationally centred on a second reference frame different from the first reference frame; estimating the visual plausibility of the estimated view; and adjusting the system in dependence on that estimate. This can help to train the system efficiently.

The method may be performed by a computer executing code stored in a non-transient form. The code may be a stored computer program.

The method may comprise: sensing by an image sensor an image of a real environment; sensing, by a depth sensor, a first depth map of the real environment, the first depth map having a first sparsity; and forming, by means of the system and in dependence on the image and the first depth map, a second depth map of the real environment, the second depth map having less sparsity than the first depth map. This can help to augment the data from a real-world depth sensor in dependence on data from a real-world camera.

The method may comprise controlling a self-driving vehicle in dependence on the second depth map. This can help to improve the accuracy of the vehicle's driving.

According to a second aspect, there is provided an example environmental analysis system formed by a method as set out above.

According to a third aspect, there is provided an example environmental analysis engine comprising: an image sensor for sensing images of an environment; a time of flight depth sensor; and an environmental analysis system as set out in the preceding paragraph; the environmental analysis system being arranged to receive images sensed by the image sensor and depths sensed by the depth sensor and thereby form estimates of the depths of objects depicted in the images.

According to a fourth aspect, there is provided an example self-driving vehicle comprising an environmental analysis engine as set out in the preceding paragraph, the vehicle being configured to drive in dependence on the estimates of the depths of objects depicted in the images.

According to a fifth aspect, there is provided an example cellular communications terminal comprising an environmental analysis engine as set out in the third aspect.

### BRIEF DESCRIPTION OF THE DRAWINGS

The present disclosure will now be made by way of example with reference to the accompanying drawings. In the drawings:

FIG. 1 illustrates distance measurements made using a LiDAR Sensor.

FIG. 2 shows the effect of an example of a generic depth completion pipeline.

FIG. 3(a) shows a synthetically created rendering using an example driving simulator.

FIG. 3(b) shows an example real driving scene.

FIG. 4 illustrates example geometric sensor imitation.

FIGS. 5(a) and 5(b) show example sensor-specific data patterns.

FIGS. 6(a) and 6(b) show an example stereo pair from driving.

FIG. 7 shows an example wrongly projected image.

FIG. 8 illustrates an example adversarial approach to correct with virtual projections.

FIG. 9 shows an example multi-modal sensing system on a vehicle.

FIG. 10 shows a synthesized RGB image and its depth map.

FIG. 11 illustrates example depth sparsification with Bernoulli point dropping.

FIG. 12 shows an example projection of RGB from left to right.

FIG. 13 illustrates an example student-teacher training scheme.

FIG. 14 shows an example domain adaptation pipeline

FIG. 15 shows an example of a camera configured to implement the methods described herein.

FIG. 16 shows example results on the synthetic domain.

FIG. 17 shows example results on real domain.

FIG. 18 shows the results of an example quantitative analysis and ablation study.

### DETAILED DESCRIPTION

The present description relates to training a machine learning system, otherwise known as an artificial intelligence model, to form a relatively dense depth map in dependence on a sparser or less dense depth map and an image (e.g. an RGB image) of a scene. A depth map is a set of data describing depths from a location to objects along a series of vectors extending at different directions from the location. If the depth map is derived directly from a real world sensor then the data may be depth measurements. Conveniently, the AI model can be trained using modern rendering engines and by formulating a pipeline that is fully trained on synthetic data without real ground truth or additional sensors. Then the trained model can be used to estimate depths from real data, for example in a self-driving or collision-avoiding vehicle or a smartphone.

A domain adaptation pipeline for sparse-to-dense depth image completion is fully trained on synthetic data without real ground truth (i.e. ground truth training data derived from real environmental sensing, for example by depth sensors for sensing real-world depth data) or additional sensors (e.g. a second camera or an inertial measurement unit (IMU)). While the pipeline itself is agnostic to the sparse sensor hardware, the system is demonstrated with the example of LiDAR data as commonly used in driving scenarios where an RGB camera together with other sensors is mounted on the roof of a car. The present system is usable in other scenarios.

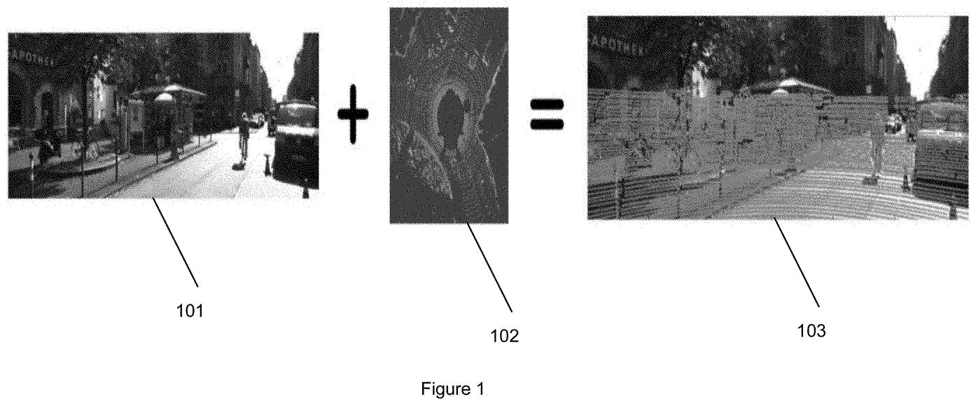

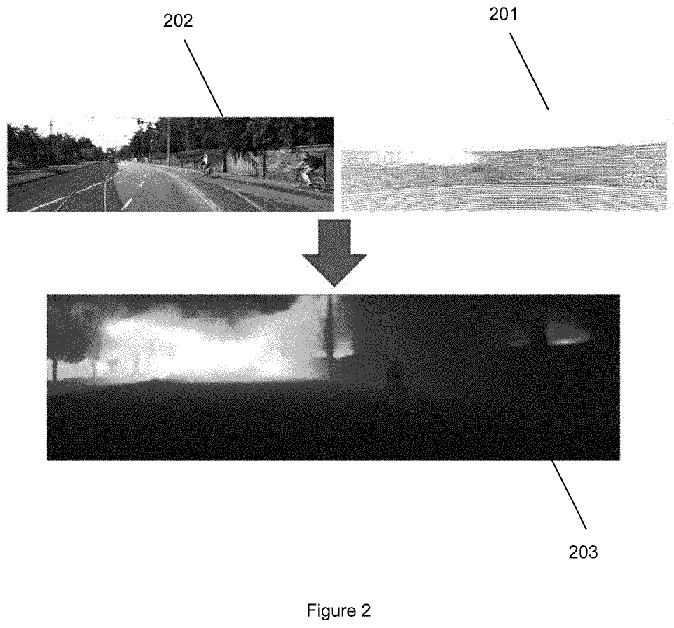

FIG. 1 illustrates that an example RGB, black and white or greyscale image 101 of a scene can be processed together with a depth data of the scene 102 to produce a map 103 indicating the depths of objects in the scene from a given point. FIG. 2 illustrates that an example RGB, black and white or greyscale image 202 of a scene can be processed together with a relatively sparse depth map 201 of the scene to infer a more detailed depth map 203.

Domain adaptation is used to imitate real sensor noise. The solution described herein comprises four modules: geometric sensor imitation, data-driven sensor mimicking, semi-supervised consistency and virtual projections.

Example embodiments of the present disclosure can be trained using ground truth data derived exclusively from the synthetic domain, or can be used alongside self-supervised methods.

### Geometric Sensor Imitation

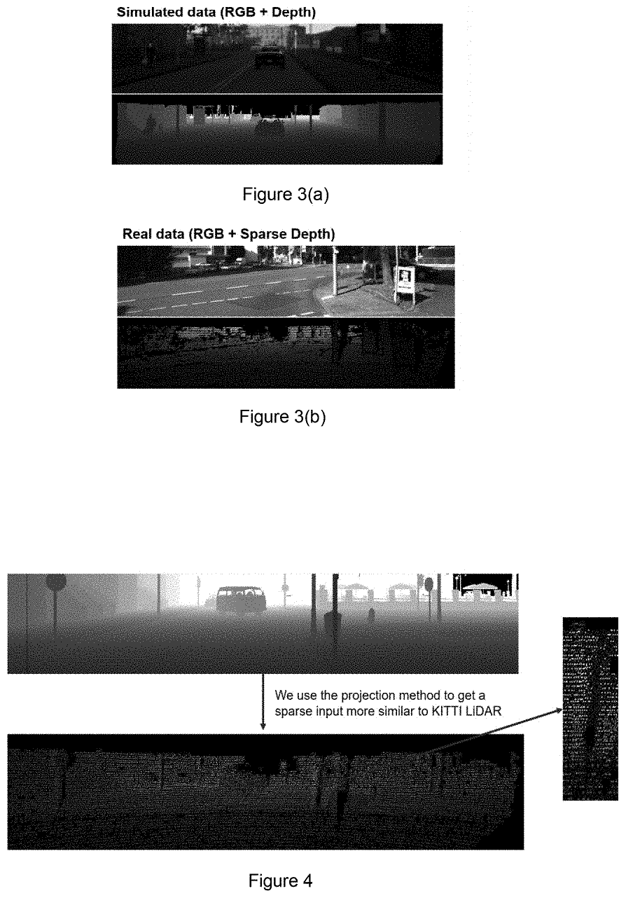

In certain embodiments, the two domains for synthetically created images and real acquisitions are differentiated as shown in FIGS. 3(a) and 3(b), which indicates an example domain gap between synthetic and real data. A synthetically created pair consisting of an RGB image and a depth map can be retrieved densely in the synthetic domain while a LiDAR scanner that scans the surroundings creates a sparse signal if its 3D point cloud is projected onto the reference view of the RGB image. To create these, a synthetic environment can be modelled. Then an RGB image of that environment from a chosen viewpoint can be formed, along with a depth map from that viewpoint. For training purposes, the same can be repeated from multiple viewpoints to form a larger set of training data.

FIG. 3(a) shows an example synthetically created rendering using a driving simulator (Dosovitskiy, Alexey, German Ros, Felipe Codevilla, Antonio Lopez, and Vladlen Koltun. “CARLA: An open urban driving simulator.” arXiv preprint arXiv:1711.03938 2017) with the RGB image on top and the intensity-coded depth map on the bottom (further away regions are brighter). FIG. 3(b) shows an example real driving scene (from Geiger, Andreas, Philip Lenz, and Raquel Urtasun, “Are we ready for autonomous driving? The kitti vision benchmark suite,” 2012 IEEE Conference on Computer Vision and Pattern Recognition, CVPR 2012) with an RGB acquisition (top) and the projected LiDAR point cloud (bottom). While the synthetic depth data is dense, the LiDAR projection creates a sparse depth map on the RGB reference view.

The inherent domain gap is apparent to a human observer. The effectiveness of the AI model can be improved by imitating a real noise pattern on the virtual domain. In order to simulate the LiDAR pattern on the synthetic data, different sparsification approaches can be chosen. Existing methods (e.g. Ma, Fangchang, and Sertac Karaman. “Sparse-to-dense: Depth prediction from sparse depth samples and a single image.” 2018 IEEE International Conference on Robotics and Automation. ICRA 2018) draw with a probability p from a Bernoulli distribution independent of surrounding pixels. In embodiments of the present disclosure, the geometric information from the real scenario is used in order to imitate the signal on the real domain. The depth sensor is placed at a similar relative spatial location (LiDAR reference) with respect to the RGB image as in the real domain. To imitate the sensor signal in its sparsity, the sampling rate is then reduced by using a binary projection mask on the LiDAR reference and project to the synthesized views. The resulting synthesized sparse signal is visually much closer to the real domain than in at least some existing approaches (as shown in FIG. 4).

FIG. 4 shows an example virtual depth map (top image) created for a similar spatial location (LiDAR reference) to the RGB image. A real mask on the LiDAR reference is used for sampling. The projected point cloud on the RGB reference (lower part) is visually closer to the real domain than random sampling of the points (e.g., using a naïve Bernoulli sampling).

### Data-Specific Sensor Imitation

The geometrically corrected sparse signal from the previous step is closer to the real domain than in at least some other synthetic approaches. However, it has been found that further processing to match the real distribution is beneficial. This can be done by modelling two further filters.

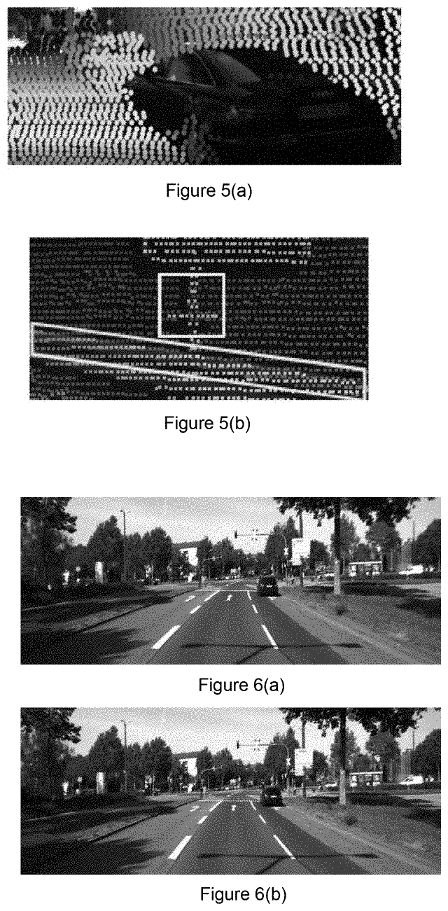

One effect is that in a real system dark areas are less reflective to the LiDAR signal and thus contain fewer 3D points. Another effect is that the rectification process induces depth ambiguities in self-occluded regions visible e.g. at thin structures. The LiDAR sensor can see beyond the RGB view and measures some objects in the “shadow” of thin structures. Due to the sparsity of the signal, these measurements do not necessarily coincide on one ray from the RGB view and thus appear simultaneously on its projection. FIGS. 5(a) and 5(b) illustrate both of these cases.

In FIG. 5(a), the example projection from a scene with a dark object (black car) is shown. While the LiDAR projection on the structures in the surroundings is homogeneous, the dark car has significantly fewer 3D measurements on its surface. In FIG. 5(b) (from Cheng, Xuelian, Yiran Zhong, Yuchao Dai, Pan Ji, and Hongdong Li, “Noise-Aware Unsupervised Deep Lidar-Stereo Fusion,” CVPR 2019), the shadow of the pole (black region) is a cause of the LiDAR sensor being mounted to the right of the camera on which reference view we observe the projected points. The sparse sampling in the boxed regions shows depth ambiguities caused by the projection to the other reference where the points are actually occluded.

In order to mimic such sensor behaviour, data cleaning may be enforced on the real domain by removing the potentially misaligned and noisy sparse signals (as shown in FIGS. 5(a) and 5(b)). This is realized by using a point dropping filter on the data with a hard threshold. If the difference between the predicted depth and the sparse input is larger than the specified threshold, the point will not be used for sparse supervision.

An additional selective sparsification process is performed on the synthetic domain, where points from the sparse input are deleted dependent on the RGB image. While a naïve approach to delete points would independently drop points given a specific dropping distribution, a probability distribution may be learned for realistic point dropping on the synthetic domain. Real LiDAR-RGB pairs may be used to learn an RGB-conditioned model to drop points where it is more probable (e.g. on dark areas as shown in FIGS. 5(a) and 5(b)).

Moreover, random point drops in the input LiDAR and consecutive recovering is used to provide a sparse supervision signal on the real domain.

### Virtual Projections

Most current models that train with self-supervision assume the presence of multiple available sensors. Usually a second RGB camera is used together with a photometric loss between two views—these could come from a physical left-right stereo pair or from consecutive frames in a video sequence in order to train a model that estimates depth.

FIGS. 6(a) and 6(b) illustrate two example images (top and bottom) from the KITTI dataset. Even though spatially placed at different locations, the scene content is very similar. (See Geiger, Andreas, Philip Lenz, and Raquel Urtasun, “Are we ready for autonomous driving? The kitti vision benchmark suite,” 2012 IEEE Conference on Computer Vision and Pattern Recognition, CVPR 2012). Simultaneous acquisition has been done with two similar cameras that are spatially placed at different locations. The left RGB image is shown on the top in FIG. 6(a), the right stereo image on the bottom in FIG. 6(b).

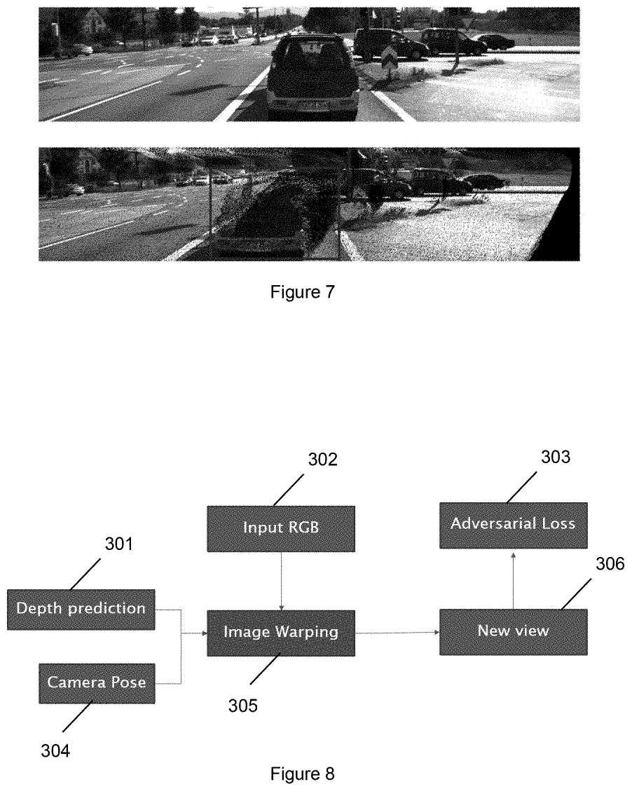

Given the depth map for the top image, for instance, one can project the RGB values onto the bottom image (or vice versa). As long as the dense depth map is correct, the resulting image will look very similar to the view from the left side despite view-dependent occlusions. However, in the case of wrong depth estimates, the errors become clearly visible as shown for example in FIG. 7, where the correctly estimated areas such as the street and the signs do produce correct-looking image regions while the parts around the car in the middle create highly erroneous image content emphasizing the flying pixels in the free space around the depth discontinuities at the car edges.

Example embodiments of the present disclosure make use of the observation that projections unravel problematic depth regions by using synthesized new views together with an adversarial loss on the new view after warping. Thus, the adversarial method helps to align the projections from simulated and real data. While any camera pose can be used for the projection, no additional sensing is needed for this approach: FIG. 8 illustrates the pipeline schematically. To further enhance the quality, the method can also be combined with view-consistency, for instance by cyclic consistency checks with back-projection to the origin.

FIG. 8 shows an adversarial approach to correct with virtual projections. The depth prediction 301 on the RGB input (left) is used with an input camera pose (left) 304 to warp 305 the input RGB image (top) 302 to virtually create a new view 306 that is evaluated by an adversarial loss 303 to help aligning the problematic regions that can be penalized strongly after warping.

### Semi-Supervised Consistency

One way to utilize domain adaptation and close domain gaps is by creating pseudo labels on the target domain. Example embodiments of the present disclosure achieve this by utilizing consistency with self-generated labels during training. A semi-supervised method is applied to the depth completion task by creating depth maps in the real domain that act as pseudo labels. Noisy pseudo predictions may be combined to pull a noisy model during training.

While there are multiple ways to realize semi-supervised consistency, some example embodiments of the present disclosure follow the approach of Tarvainen and Valpola (Tarvainen, Antti, and Harri Valpola. “Mean teachers are better role models: Weight-averaged consistency targets improve semi-supervised deep learning results.” NeurIPS 2017).

Put another way, these example embodiments use a domain adaptation pipeline for depth completion with the following notable stages:
1. Geometric Sensor Imitation
   Using the real-data pattern and projection of artefacts on the synthetic domain.
2. Data-Specific Sensor Imitation
   Selective sparsification and data refinement.
3. Virtual Projections of Predictions to Other Views to Reveal Errors in Prediction
   Change in perspective reveals incorrect depth. This observation is used with an adversarial loss.
4. Application of a Semi-Supervised Approach to Enforce Consistency with Self-Generated Depth Maps
   A mean teacher is used for semi-supervised learning with sparse point supervision.

An implementation of this approach for the specific exemplar use case of RGB and LiDAR fusion in the context of driving scenes will now be described. For data generation, some example embodiments of the present disclosure may use the driving simulator CARLA (see Dosovitskiy, Alexey, German Ros, Felipe Codevilla, Antonio Lopez, and Vladlen Koltun. “CARLA: An open urban driving simulator.” arXiv preprint arXiv:1711.03938 2017) and the real driving scenes from the KITTI dataset, as described in Geiger, Andreas, Philip Lenz, and Raquel Urtasun, “Are we ready for autonomous driving? The kitti vision benchmark suite,” 2012 IEEE Conference on Computer Vision and Pattern Recognition, CVPR 2012.

### Sensor and Data Imitation

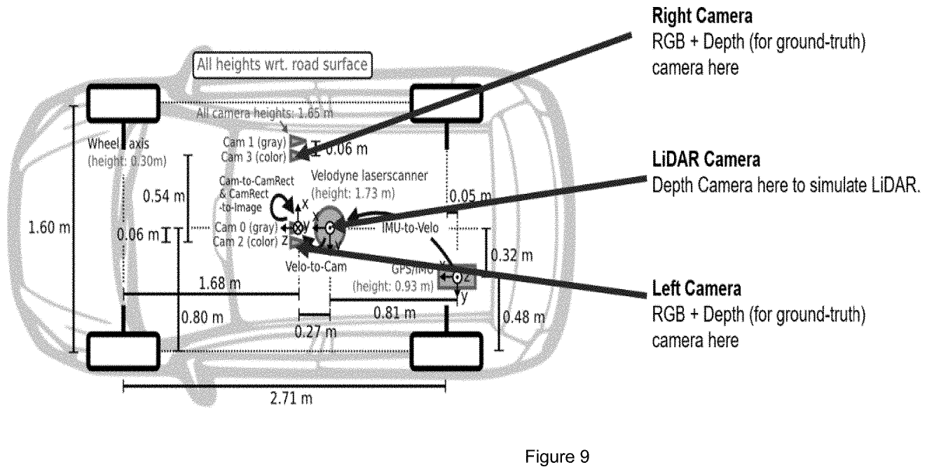

The KITTI dataset assumes an automobile equipped with multiple sensing systems as illustrated in FIG. 9. Cameras may be virtually placed in a simulation environment at the same relative spatial locations as the stereo camera pair and the sparse LiDAR sensor on the KITTI vehicle. For convenience, this information is added to the graphical illustration.

FIG. 9 shows an example multi-modal sensing system on a vehicle (in this case a car). The car is equipped with multiple sensors at different spatial locations. The two stereo camera setups (Cam 0-Cam 1 for grey-scale imaging and Cam 2-Cam 3 for RGB) are placed in front of a Velodyne LiDAR scanner between the car axes. An additional IMU/GPS module is held in the back of the car. The virtual cameras may be placed on the synthetic domain at the same relative locations as the RGB cameras indicated by the arrows.

While the ground truth data for the driving dataset (see Geiger, Andreas, Philip Lenz, and Raquel Urtasun, “Are we ready for autonomous driving? The kitti vision benchmark suite,” 2012 IEEE Conference on Computer Vision and Pattern Recognition) is retrieved with an intense processing stage leveraging temporal and car pose information, our simulator can project the depth information of the environment onto the same frame of reference as the synthetic placement of the RGB cameras to retrieve ground truth supervision on the synthetic domain.

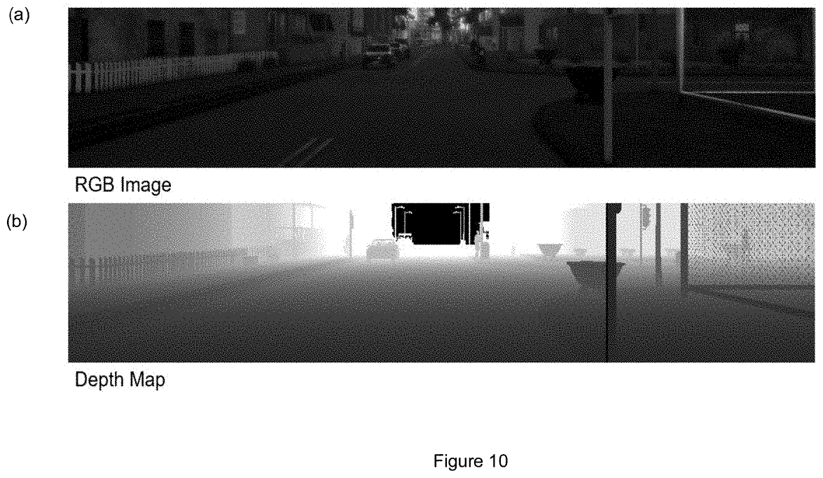

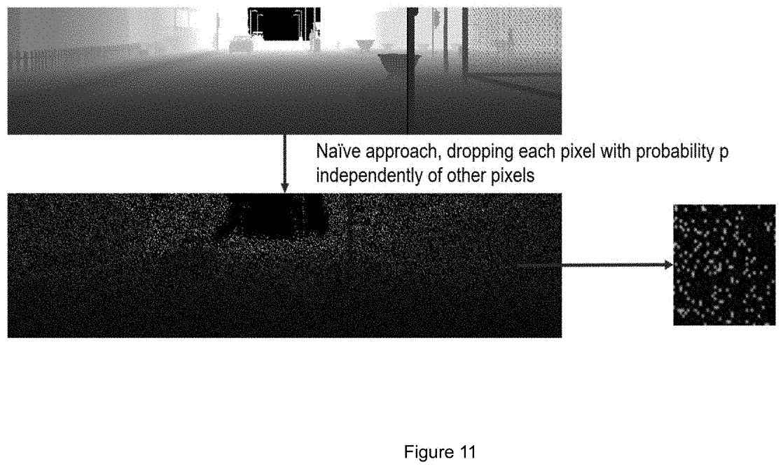

As a first step, towards simulating the LiDAR pattern, a depth map on the virtual LiDAR reference may be retrieved as illustrated in FIG. 10. FIG. 10 shows a synthesized RGB and depth map. The top image (a) of FIG. 10 illustrates a scene in the simulator for which an RGB image has been rendered. The lower image (b) of FIG. 10 colour-codes (brighter is farther) the depth map of the same scene seen from the LiDAR frame of reference. In order to sparsify the input depth map, sensor imitation is used. While a Bernoulli sampling as proposed by Ma, Fangchang, and Sertac Karaman. “Sparse-to-dense: Depth prediction from sparse depth samples and a single image.” 2018 IEEE International Conference on Robotics and Automation (ICRA 2018), as illustrated in FIG. 11 provides sparse data with a different appearance than on the real domain, an example embodiment uses LiDAR masks from the real domain and learns RGB-conditioned point dropping to produce realistically looking LiDAR data as shown in FIG. 4.

FIG. 11 shows example depth sparsification with Bernoulli point dropping. The depth map illustrated on top (brighter is farther) is sparsified with random point dropping. The illustration (lower image left) shows the result if the probability distribution for random dropping is a Bernoulli distribution. The enlarged region (lower right) illustrates the result of this context-independent point dropping for a smaller region.

### Virtual Projections

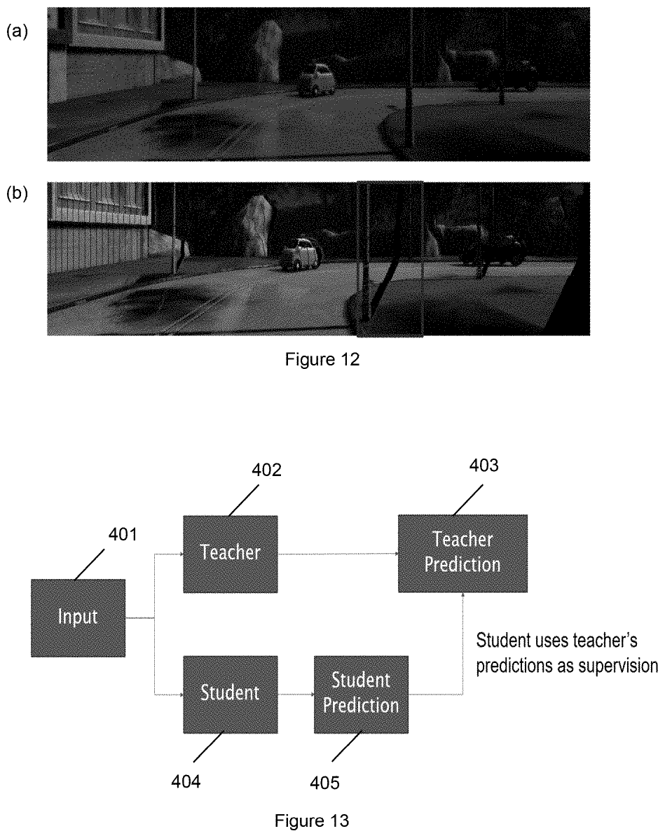

The virtual projection of RGB images from left to right makes it easier to notice depth estimation errors. A projection from a synthetic left RGB image to the right view with ground truth depth is depicted in FIG. 12. While the line-of-sight occlusions are visible, the colour placing is correct whereas the same process with incorrectly estimated depth induces obvious artefact as shown in FIG. 7. This is used with an adversarial loss on the warped image and identifies failure cases to update network parameters during training.

### Semi-Supervised Consistency

There are different ways to realize semi-supervision. A teacher-student model is implemented to provide a pseudo dense supervision on the real domain that uses weight-averaged consistency targets to improve the network output. In our realization, a mean-teacher (see Tarvainen, Antti, and Harri Valpola, “Mean teachers are better role models: Weight-averaged consistency targets improve semi-supervised deep learning results,” NeurIPS 2017) is used to improve the predictions with a noisy pseudo-ensembled pulling of a student prediction. The process architecture is illustrated in FIG. 13 where two copies of the same network (teacher and student) are used during training. FIG. 13 shows an example student-teacher training scheme. An input is fed to two copies of the same network, namely teacher and student. For each of the branches, different augmentations and noise are added. The teacher creates a pseudo supervision signal to train the student and an exponentially moving average of the student weights is used to update the teacher parameters during training. At each training step, the same minibatch is fed to both models with different augmentations and separately added noise. While the student weights are updated in the normal way, the teacher's weights are an exponentially moving average of the student weights to make the prediction consistent across iterations. In this way, the teacher is updated a small step in the direction of the student. After the training phase, the teacher's pseudo labels are not needed anymore and the student network is applied to estimate dense depth.

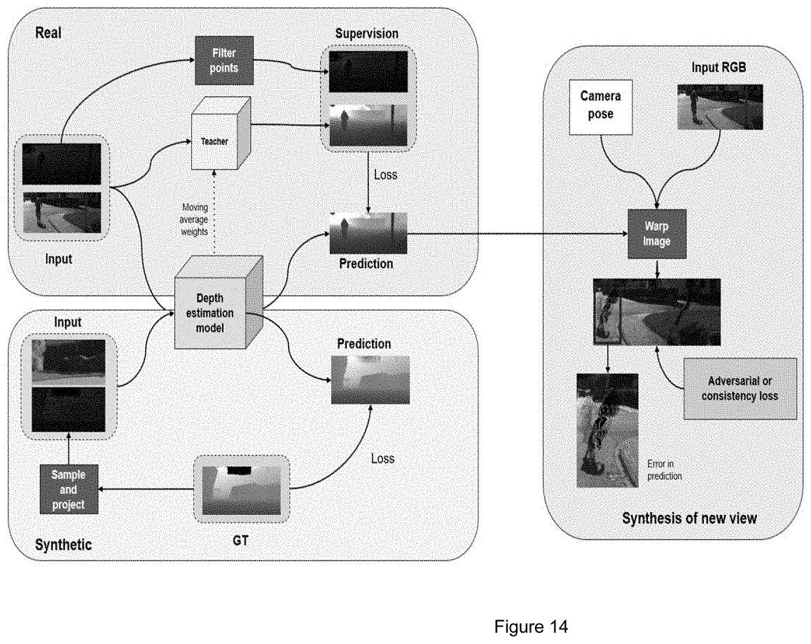

An example whole pipeline including all mentioned domains and modules is illustrated in the overview FIG. 14.

FIG. 14 shows an example domain adaptation pipeline. The three boxes illustrate the synthetic and real domain as well as the synthetically created new views. On the synthetic domain (lower left box), sensor imitation is used to create an input signal pair of RGB and LiDAR from the rendered full ground truth (GT) depth map. The depth estimation model is supervised by the ground truth and shared with the real domain where the input is RGB and LiDAR, too. The points are filtered on the real domain (upper left box) to create an additional sparse signal from LiDAR for supervision. Semi-supervision is realized with the student-teacher model (the student in this graphic is depicted as depth estimation model) where the teacher network is used only during training time. A camera pose defines the differentiable warping of the input RGB image onto a new reference (e.g. the right view) where an adversarial or consistency loss can be applied to identify the errors in prediction and help updating the weights.

### Results and Comparison to Other Pipelines

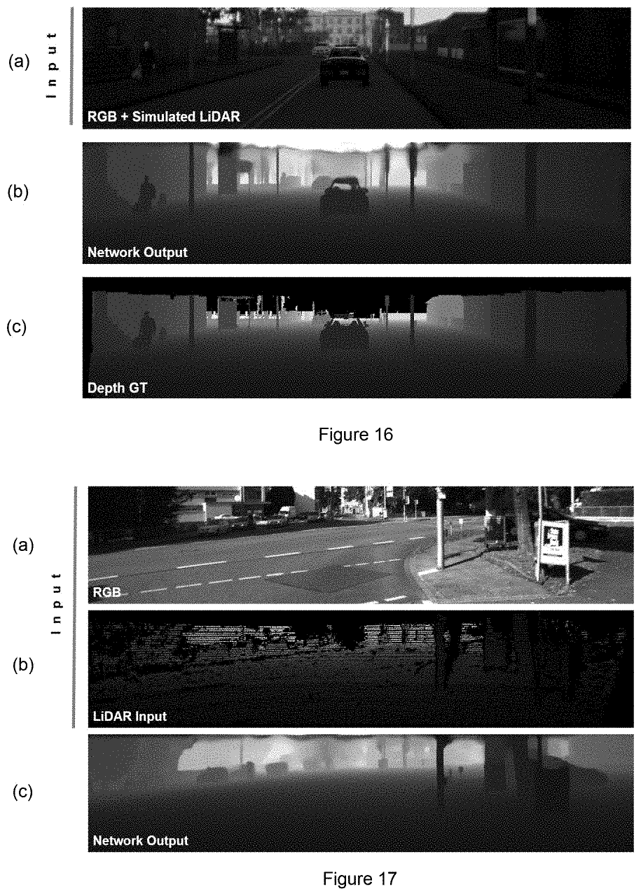

Qualitative results are shown for synthetic images in FIG. 16 and for the real domain in FIG. 17. Interestingly, the network outputs also plausible values in regions where there is no depth information present on the ground truth in the simulation case showing that the network has learned the generalization and completion induced by RGB information. A similar effect can be viewed on the real domain where the areas that do not include LiDAR data are also predicted accurately with plausible information.

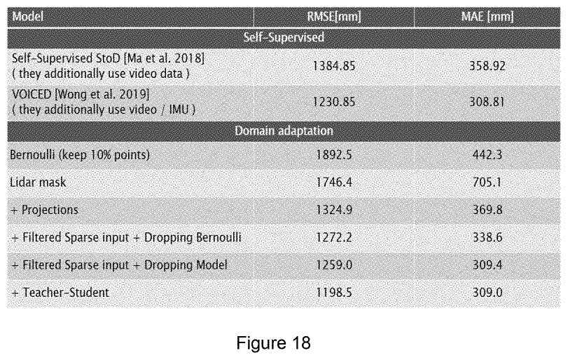

FIG. 18 illustrates a quantitative analysis with an ablation study of the different modules where the method is compared to state-of-the-art self-supervised methods. By adding the different modules consecutively, one can see an improvement in each step which supports the proposition that each part is helping with the task of depth completion. A system that used only some of the parts would be possible, but would be expected to be less effective. The error evaluation also shows that the presented approach is on par with modern self-supervised methods, even though they use additional sensor information from a second virtual camera (see Ma, Fangchang, Guilherme Venturelli Cavalheiro, and Sertac Karaman, “Self-supervised sparse-to-dense: Self-supervised depth completion from lidar and monocular camera,” International Conference on Robotics and Automation, ICRA 2019) and another modality [Wong, Alex, Xiaohan Fei, and Stefano Soatto, “VOICED: Depth Completion from Inertial Odometry and Vision,” arXiv preprint arXiv:1905.08616. 2019].

FIG. 17 shows example results in the real domain. The top image (a) in FIG. 17 shows the RGB input, the middle image (b) in FIG. 17 shows the sparse LiDAR signal projected onto the RGB reference, and the lower image (c) in FIG. 17 shows the network output. It can be seen that thin structures are retrieved accurately and the depth completion fills holes between the relatively sparse LiDAR points as well as line-of-sight occlusions (e.g. around the pole in the right centre) and provides depth estimates for distant objects where there is only RGB information present. Also dark areas such as the car to the right are filled with plausible depth values in the absence of Li DAR information.

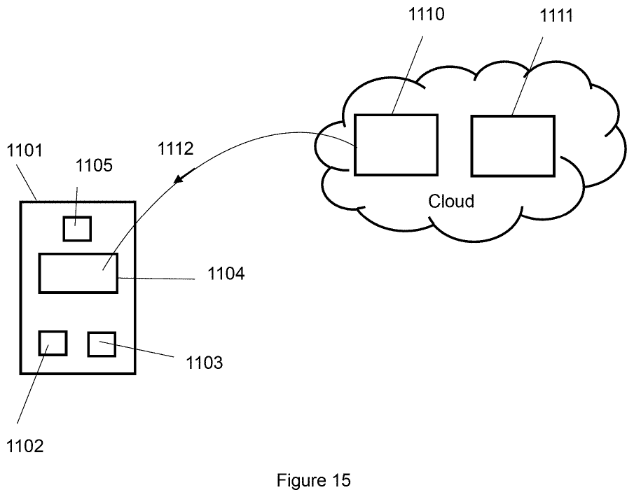

FIG. 15 shows an example of a camera 1101 configured to implement the image processor to process images taken by an image sensor 1102 in the camera 1101. Such a camera 1101 typically includes some onboard processing capability. This could be provided by the processor 1104. The processor 1104 could also be used for the essential functions of the device. The camera typically also comprises a memory 1103.

The transceiver 1105 is capable of communicating over a network with other entities 1110, 1111. Those entities may be physically remote from the camera 1101. The network may be a publicly accessible network such as the internet. The entities 1110, 1111 may be based in the cloud. In one example, the entity 1110 is a computing entity and the entity 1111 is a command and control entity. These entities are logical entities. In practice, they may each be provided by one or more physical devices such as servers and datastores, and the functions of two or more of the entities may be provided by a single physical device. Each physical device implementing an entity comprises a processor and a memory. The devices may also comprise a transceiver for transmitting and receiving data to and from the transceiver 1105 of camera 1101. The memory stores in a non-transient way code that is executable by the processor to implement the respective entity in the manner described herein.

The command and control entity 1111 may train the artificial intelligence models used in each module of the system. This is typically a computationally intensive task, even though the resulting model may be efficiently described, so it may be efficient for the development of the algorithm to be performed in the cloud, where it can be anticipated that significant energy and computing resource is available. It can be anticipated that this is more efficient than forming such a model at a typical camera.

In one implementation, once the deep learning algorithms have been developed in the cloud, the command and control entity can automatically form a corresponding model and cause it to be transmitted to the relevant camera device. In this example, the system is implemented at the camera 1101 by processor 1104.

In another possible implementation, an image may be captured by the image sensor 1102 and the image data may be sent by the transceiver 1105 to the cloud for processing in the system. The resulting target image could then be sent back to the camera 1101, as shown at 1112 in FIG. 15.

The method may be deployed in multiple ways, for example in the cloud, on the device, or alternatively in dedicated hardware. As indicated above, the cloud facility could perform training to develop new algorithms or refine existing ones. Depending on the compute capability near to the data corpus, the training could either be undertaken close to the source data, or could be undertaken in the cloud, e.g. using an inference engine. The system may also be implemented at the camera, in a dedicated piece of hardware, or in the cloud.

A vehicle may be equipped with a processor programmed to implement a model trained as discussed above. The model may take inputs from image and depth sensors carried by the vehicle, and may output a denser depth map. That denser depth map may be used as input to a self-driving or collision avoidance system for controlling the vehicle.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present disclosure may consist of any such individual feature or combination of features. In view of the foregoing description it will be evident to a person skilled in the art that various modifications may be made within the scope of the disclosure.

1. A method for training an environmental analysis system, comprising:
receiving a data model of an environment;
forming, in dependence on the data model, a first training input comprising a visual stream representing the environment as viewed from a plurality of locations;
forming, in dependence on the data model, a second training input comprising a depth stream representing depths of objects in the environment relative to the plurality of locations;
forming a third training input comprising a depth stream representing the depths of the objects in the environment relative to the plurality of locations, the third training input being sparser than the second training input;
estimating, using the environmental analysis system and in dependence on the first and third training inputs, a series of depths at less sparsity than the third training input; and
adapting the environmental analysis system in dependence on a comparison between the estimated series of depths and the second training input.

2. A method as claimed in claim 1, wherein the environmental analysis system is a machine learning system having a series of weights and the adapting of the environmental analysis system comprises adapting the series of weights.

3. A method as claimed in claim 1, wherein the third training input is filtered to simulate data resulting from a physical depth sensor.

4. A method as claimed in claim 3, wherein the third training input is filtered to simulate data resulting from a scanning depth sensor.

5. A method as claimed in claim 1, wherein the third training input is augmented by adding noise.

6. A method as claimed in claim 1, further comprising forming the third training input by filtering the second training input.

7. A method as claimed in claim 1, wherein the second training input and the third training input represent depth maps.

8. A method as claimed in claim 7, wherein the third training input is augmented to include, for each of the plurality of locations, depth data for vectors extending at a common angle to vertical from the respective location.

9. A method as claimed in claim 7, wherein the third training input is filtered by excluding data for vectors that extend from one of the plurality of locations to an object that has been determined to be at a greater or smaller depth further away from an estimate than a predetermined threshold.

10. A method as claimed in claim 7, wherein the third training input is filtered by excluding data for vectors in dependence on a colour represented in a visual stream of an object towards which the respective vectors extend.

11. A method as claimed in claim 1, wherein the data model is a model of a synthetic environment.

12. A method as claimed in claim 1, further comprising repeatedly adapting the environmental analysis system and performing a majority of such adaptations in dependence on data describing one or more synthetic environments.

13. A method as claimed in claim 1, wherein the system is trained using a semi-supervised learning algorithm.

14. A method as claimed in claim 1, further comprising training the system by:
providing a view of the environment orientationally and translationally centred on a first reference frame as input to the system and, in response to that input, estimating, using the system, the depths associated with pixels in that view;
forming, in dependence on that view and the estimated depths, an estimated view of the environment orientationally and translationally centred on a second reference frame different from the first reference frame;
estimating visual plausibility of the estimated view; and
adjusting the system in dependence on the estimation of the visual plausibility.

15. A method as claimed in claim 1, wherein the method is performed by a computer executable code stored in a non-transient form.

16. A method as claimed in claim 1, comprising:
Sensing, by an image sensor, an image of a real environment;
sensing, by a depth sensor, a first depth map of the real environment, the first depth map having a first sparsity; and
forming, using the system and in dependence on the image and the first depth map, a second depth map of the real environment, the second depth map having less sparsity than the first depth map.

17. A method as claimed in claim 16, comprising:
controlling a self-driving vehicle in dependence on the second depth map.

18. An environmental analysis device comprising:
an image sensor for sensing images of an environment;
a time-of-flight depth sensor; and
a processor, the processor executing code stored in a non-transient form to run an environmental analysis system, wherein the environmental analysis system is trained by:
receiving a data model of an environment;
forming, in dependence on the data model, a first training input comprising a visual stream representing the environment as viewed from a plurality of locations;
forming, in dependence on the data model, a second training input comprising a depth stream representing depths of objects in the environment relative to the plurality of locations;
forming a third training input comprising a depth stream representing the depths of the objects in the environment relative to the plurality of locations, the third training input being sparser than the second training input;
estimating, using the environmental analysis system, in dependence on the first and third training inputs, a series of depths at less sparsity than the third training input; and
adapting the environmental analysis system in dependence on a comparison between the estimated series of depths and the second training input, the environmental analysis system being arranged to receive images sensed by the image sensor and depths sensed by the time-of-flight depth sensor and thereby form estimates of the depths of objects depicted in the images.

19. A device as claimed in claim 18, wherein the environmental analysis system is a machine learning system having a series of weights and the adapting of the environmental analysis system comprises adapting the series of weights.

20. A device as claimed in claim 18, wherein the third training input is filtered to simulate data resulting from a physical depth sensor.
